(19) United States
(12) Patent Application Publication
(10) Pub. No.: US 2025/0237558 A1
(43) Pub. Date: Jul. 24, 2025

(54) Temperature sensing circuit and temperature detecting method

(71) Applicant: PixArt Imaging Inc., Hsin-Chu City (TW)

(72) Inventor: Kok Siang Tan, Penang (MY)

(73) Assignee: PixArt Imaging Inc., Hsin-Chu City (TW)

(21) Appl. No.: 18/420,785

(22) Filed: Jan. 24, 2024

(51) Int. Cl. G01K 7/34

(52) U.S. Cl. CPC G01K 7/34

(57) ABSTRACT

A temperature sensing circuit employs a combination of current sources, capacitors, switches, two sensing amplifiers, an XOR gate, and a counter to accurately measure temperature within a specific range. The temperature sensing circuit uses three current sources, each with distinct characteristics, along with three capacitors for voltage storage. Switches are employed to control the flow of currents, while the two sensing amplifiers compare voltage levels to determine two time durations. An XOR gate processes the outputs from the two sensing amplifiers, and a counter utilizes a clock signal to sample the output from the XOR gate based on the two time durations, so as to provide a digital representation of the temperature.

### BACKGROUND OF THE INVENTION

### 1. Field of the Invention

The present invention relates to a temperature sensing circuit and a method for detecting the temperature, and particularly relates to a voltage comparing circuit and a voltage comparing method which can be applied to detect a temperature.

### 2. Description of the Prior Art

Temperature sensing circuits are used to measure the temperature of an object or environment. They are utilized in a wide variety of applications, including industrial processes, medical devices, and consumer electronics. A traditional temperature sensing circuit requires an analog-to-digital 1 converter (ADC), which occupies a large area and consumes significant power.

### SUMMARY OF THE INVENTION

An embodiment of the present invention provides a temperature sensing circuit. The temperature sensing circuit comprises a first current source, a second current source, a third current source, a first capacitor, a second capacitor, a third capacitor, a first switch, a second switch, a third switch, a first sensing amplifier, a second sensing amplifier, an XOR gate, and a counter. The first current source is configured to provide a first current, and the first current is constant within a temperature range to be detected by the temperature sensing circuit. The second current source is configured to provide a second current, and the second current is proportional to an absolute temperature within the temperature range. The third current source is configured to provide a third current, and the third current is constant within the temperature range. The first capacitor is coupled to the first current source and a reference voltage. The second capacitor is coupled to the second current source and the reference voltage. The third capacitor is coupled to the third current source and the reference voltage. The first switch is coupled in parallel with the first capacitor. The second switch is coupled in parallel with the second capacitor. The third switch is coupled in parallel with the third capacitor. The first sensing amplifier has a first input coupled to the second current source and the second capacitor, and a second input coupled to the third current source and the third capacitor. The second sensing amplifier has a first input coupled to the first current source and the first capacitor, and a second input coupled to the third current source and the third capacitor. The XOR gate has a first input coupled to an output of the first sensing amplifier, and a second input coupled to an output of the second sensing amplifier. The counter is configured to sample an output signal outputted from the XOR gate according to a clock signal.

Another embodiment of the present invention provides a method of detecting a temperature. The method comprises charging a first capacitor using a first charge current within a first time duration to provide a first voltage at one end of the first capacitor at an end of the first time duration; charging a second capacitor using a second charge current within the first time duration to provide a second voltage at one end of the second capacitor at the end of the first time duration; charging a third capacitor using a third charge current within a second time duration after the first time duration to pull up a third voltage at one end of the third capacitor; measuring a time duration between a time when the third voltage exceeds the first voltage and a time when the third voltage exceeds the second voltage; and outputting a detected temperature according to the time duration. The first charge current is constant within a temperature range, the second charge current is proportional to an absolute temperature within the temperature range, and the third charge current is constant within the temperature range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a temperature sensing circuit according to an embodiment of the present invention.

FIG. 2 is a timing diagram of related signals of the temperature sensing circuit shown in FIG. 1.

FIG. 3 is a schematic diagram of a temperature sensing circuit according to another embodiment of the present invention.

FIG. 4 is a timing diagram of related signals of the temperature sensing circuit shown in FIG. 3.

FIG. 5 is a schematic diagram of a temperature sensing circuit according to another embodiment of the present invention.

FIG. 6 is a schematic diagram of a temperature sensing circuit according to another embodiment of the present invention.

### DETAILED DESCRIPTION

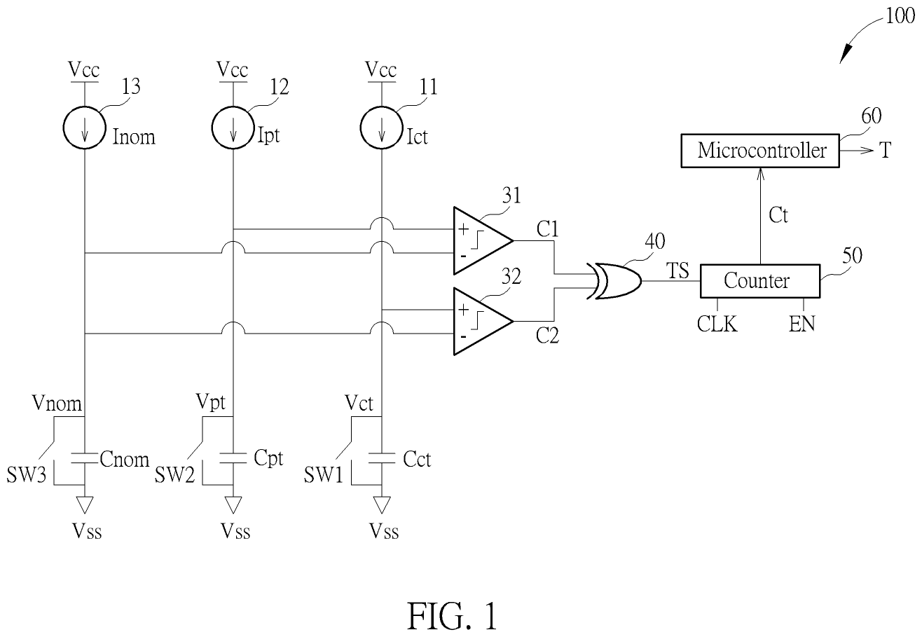

Please refer to FIG. 1. FIG. 1 is a schematic diagram of a temperature sensing circuit 100 according to an embodiment of the present invention. The temperature sensing circuit 100 is a differential sensing temperature sensor and comprises three current sources 11, 12, and 13, three capacitors Cct, Cpt, and Cnom, three switches SW1, SW2, and SW3, two sensing amplifiers 31 and 32, an XOR gate 40, a counter 50, and a microcontroller 60. The three current sources 11, 12, and 13 are coupled to a reference voltage Vcc, which is a positive power supply voltage. The current source 11 has a negative temperature coefficient and is configured to provide a current Ict. In other words, the current Ict decreases with increasing temperature. The current source 12 has a positive temperature coefficient and is configured to provide a current Ipt. In other words, the current Ipt is proportional to an absolute temperature within a temperature range to be detected by the temperature sensing circuit 100. The temperature range to be detected by the temperature sensing circuit 100, for example, may be −50 degrees Celsius to 150 degrees Celsius (i.e., −50° C. to 150° C.). The current source 13 is configured to provide a current Inom, which remains constant within the temperature range to be detected by the temperature sensing circuit 100. The capacitors Cct, Cpt, and Cnom are coupled to the current sources 11, 12, and 13, respectively, and a reference voltage Vss, which may be a ground voltage. The switches SW1, SW2, and SW3 are coupled in parallel with the capacitors Cct, Cpt, and Cnom, respectively. The sensing amplifier 31 has a first input coupled to the current source 12 and the capacitor Cpt, and a second input coupled to the current source 13 and the capacitor Cnom. The sensing amplifier 31 compares a voltage Vpt at a first end of the capacitor Cpt with a voltage Vnom at a first end of the capacitor Cnom, and outputs a comparison result C1 based on the voltages Vpt and Vnom. The sensing amplifier 32 has a first input coupled to the current source 11 and the capacitor Cct, and a second input coupled to the current source 13 and the capacitor Cnom. The sensing amplifier 32 compares a voltage Vct at a first end of the capacitor Cct with the voltage Vnom, and outputs a comparison result C2 based on the voltages Vct and Vnom. The XOR gate 40 has a first input coupled to the output of the sensing amplifier 31, and a second input coupled to an output of the sensing amplifier 32. The XOR gate 40 performs an XOR operation on the comparison result C1 and the comparison result C2 to output an output signal TS. The counter 50 is configured to sample the output signal TS according to a clock signal CLK. The counter 50 may be enabled or disabled based on an enable signal EN received from the microcontroller 60. The microcontroller 60 determines the temperature according to a count Ct of samples of the output signal TS sampled by the counter 50 during a time duration between a time when the voltage Vnom exceeds the voltage Vct and a time when the voltage Vnom exceeds the voltage Vpt.

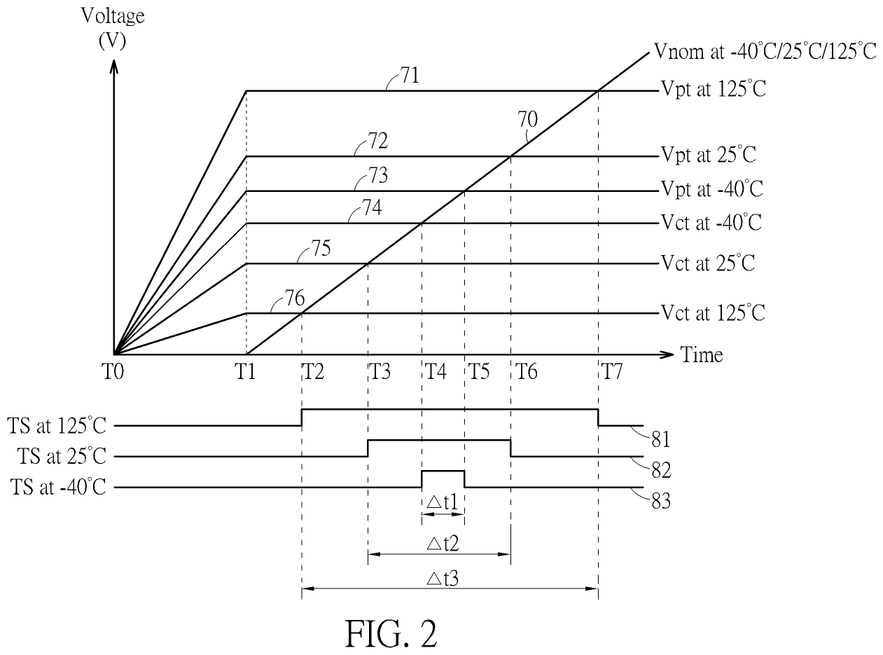

Please refer to FIG. 1 and FIG. 2. FIG. 2 is a timing diagram of related signals of the temperature sensing circuit 100 shown in FIG. 1. Before time T0, the microcontroller 60 resets the voltage difference across each of the capacitors Cct, Cpt, and Cnom to zero using the switches SW1, SW2 and SW3. In other words, the switches SW1, SW2 and SW3 are turned on to reset the voltage difference across each of the capacitors Cct, Cpt, and Cnom before time TO. In an embodiment of the present invention, the reference voltage Vss is a ground voltage, and the voltage differences across the capacitors Cct, Cpt, and Cnom are equal to Vct, Vpt, and Vnom respectively. Additionally, before time T0, the microcontroller 60 turns off the current sources 11, 12, and 13 and the sensing amplifiers 31 and 32, and resets the count Ct to 0. At time T0, the microcontroller 60 simultaneously turns off the switches SW1 and SW2, and turns on the current sources 11 and 12, while keeping the switch SW3 turned on and the current source 13 turned off. Accordingly, the capacitors Cct and Cpt are charged by the currents Ict and Ipt respectively after time TO. At time T1, the microcontroller 60 simultaneously turns off the switches SW1, SW2, and SW3, turns off the current sources 11 and 12, and turns on the current source 13. Therefore, after time T1, the voltages Vct and Vpt are held constant, and the voltage Vnom is raised from zero. The curve 70 represents the relationship between the voltage Vnom and time at different temperatures: −40° C., 25° C., and 125° C. The curve 71 represents the relationship between the voltage Vpt and time at 125° C. The curve 72 represents the relationship between the voltage Vpt and time at 25° C. The curve 73 represents the relationship between the voltage Vpt and time at −40° C. The curve 74 represents the relationship between the voltage Vct and time at −40° C. The curve 75 represents the relationship between the voltage Vct and time at 25° C. The curve 76 represents the relationship between the voltage Vct and time at 125° C.

The sensing amplifier 31 compares the voltage Vpt with the voltage Vnom to output the comparison result C1, the sensing amplifier 32 compares the voltage Vct with the voltage Vnom to output the comparison result C2, and the XOR gate 40 performs an XOR operation on the comparison result C1 and the comparison result C2 to output the output signal TS. The curves 81, 82, and 83 respectively represent the waveforms of the output signal TS at different temperatures: 125° C., 25° C., and −40° C. When the voltage Vnom exceeds the voltage Vct, the output signal TS is pulled up from low to high. When the voltage Vnom exceeds the voltage Vpt, the output signal TS is pulled down from high to low. As shown in FIG. 2, when the temperature is 125° C., the output signal TS is pulled up from low to high at time T2, and pulled down from high to low at time T7 (see the curve 81). When the temperature is 25° C., the output signal TS is pulled up from low to high at time T3, and pulled down from high to low at time T6 (see the curve 82). When the temperature is −40° C., the output signal TS is pulled up from low to high at time T4, and pulled down from high to low at time T5 (see the curve 83). The time duration between time T2 and T7 is equal to Δt3, the time duration between time T3 and T6 is equal to Δt2, and the time duration between time T4 and T5 is equal to Δt1. The microcontroller 60 determines that the temperature is −40° C. according to the time duration Δt1, determines that the temperature is 25° C. according to the time duration Δt2, and determines that the temperature is 125° C. according to the time duration Δt3.

The counter 50 may be enabled by the enable signal EN after time T1. When the counter 50 is enabled, the counter 50 samples the output signal TS to output the count Ct according to the clock signal CLK. In an embodiment of the present invention, when the voltage level of the output signal TS is high, the count Ct would be incremented by 1 at each rising edge of the clock signal CLK. The microcontroller 60 may measure the time durations Δt1, Δt2, and Δt3 according to the count Ct of samples of the output signal TS sampled by the counter 50 between a time when the voltage Vnom exceeds the voltage Vct and a time when the voltage Vnom exceeds the voltage Vpt. Therefore, the count Ct may represent the length of the time duration Δt1, Δt2, or Δt3. Since the microcontroller 60 may determine the temperature based on the measured time durations Δt1, Δt2, and Δt3, the microcontroller 60 may determine that the temperature is −40° C. according to the count Ct of samples of the output signal TS sampled by the counter 50 during the time T4 to T5, determines that the temperature is 25° C. according to the count Ct of samples of the output signal TS sampled by the counter 50 during the time T3 to T6, and determines that the temperature is 125° C. according to the count Ct of samples of the output signal TS sampled by the counter 50 during the time T2 to T7. After the microcontroller 60 determines the temperature according to the time duration Δt1, Δt2, or Δt3, the microcontroller 60 may output the detected temperature T.

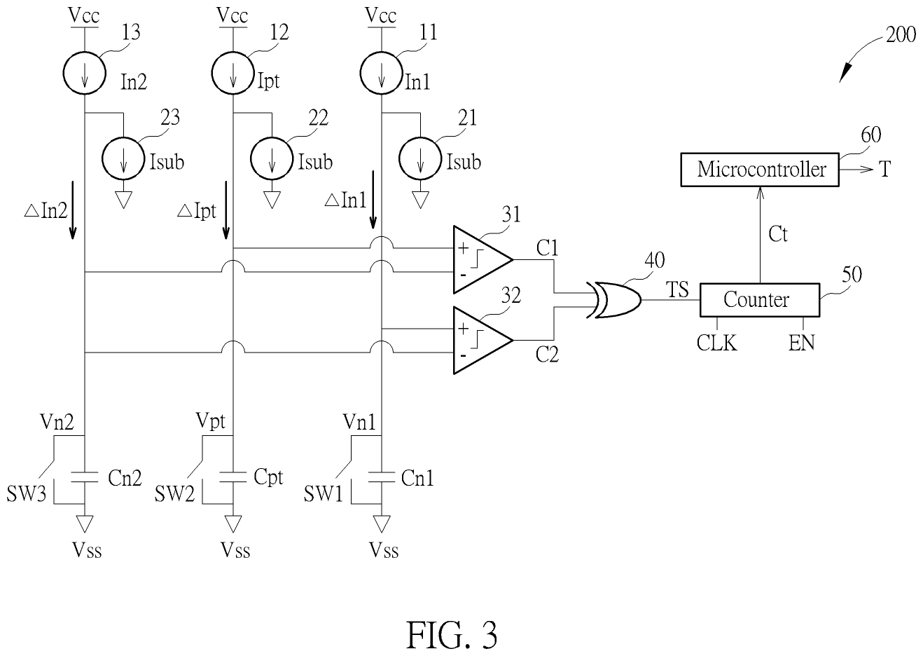

Please refer to FIG. 3. FIG. 3 is a schematic diagram of a temperature sensing circuit 200 according to another embodiment of the present invention. The temperature sensing circuit 200 is a differential sensing temperature sensor and comprises the three current sources 11, 12, and 13, three sinking current sources 21, 22, and 23, three capacitors Cn1, Cpt, and Cn2, the three switches SW1, SW2, and SW3, the two sensing amplifiers 31 and 32, the XOR gate 40, the counter 50, and the microcontroller 60. In the embodiment, the current source 11 is configured to provide a current In1, which remains constant within the temperature range to be detected by the temperature sensing circuit 200. The temperature range to be detected by the temperature sensing circuit 200, for example, may be −50 degrees Celsius to 150 degrees Celsius (i.e., −50° C. to 150° C.). However, the present invention is not limited thereto. The current source 12 has a positive temperature coefficient and is configured to provide the current Ipt, which is proportional to an absolute temperature within the temperature range to be detected by the temperature sensing circuit 200. The current source 13 is configured to provide a current In2, which remains constant within the temperature range to be detected by the temperature sensing circuit 200. Each of the sinking current sources 21, 22, and 23 provides a sinking current Isub, which is less than the currents In1, Ipt, and In2 and remains constant within the temperature range to be detected by the temperature sensing circuit 200. The sinking current Isub may be used to remove direct-current (DC) information from the currents In1, Ipt, and In2. The capacitors Cn1, Cpt, and Cn2 would be respectively charged by currents ΔIn1, ΔIpt, and ΔIn2. The current ΔIn1 is equal to (In1-Isub), the current ΔIpt is equal to (Ipt-Isub), and the current ΔIn2 is equal to (In2-Isub). Since the currents In1, In2 and Isub remain constant within the temperature range to be detected by the temperature sensing circuit 200, the currents ΔIn1 and ΔIn2 also remain constant within the temperature range to be detected by the temperature sensing circuit 200. The sensing amplifier 31 compares the voltage Vpt with a voltage Vn2 at a first end of the capacitor Cn2, and outputs the comparison result C1 based on the voltages Vpt and Vn2. The sensing amplifier 32 compares the voltage Vn2 with a voltage Vn1 at a first end of the capacitor Cn1, and outputs the comparison result C2 based on the voltages Vn2 and Vn1. Since the DC components of the currents In1, Ipt, and In2 are eliminated by the sinking current Isub, the alternating-current (AC) components of the currents In1, Ipt, and In2 are present in the currents ΔIn1, AIpt, and ΔIn2, with no DC components contained within. As a result, the voltages Vn1, Vpt, and Vn2 would be within the input common-mode range of the sensing amplifiers 31 and 32. The microcontroller 60 determines the temperature according to the count Ct of samples of the output signal TS sampled by the counter 50 during a time duration between a time when the voltage Vn2 exceeds the voltage Vn1 and a time when the voltage Vn2 exceeds the voltage Vpt.

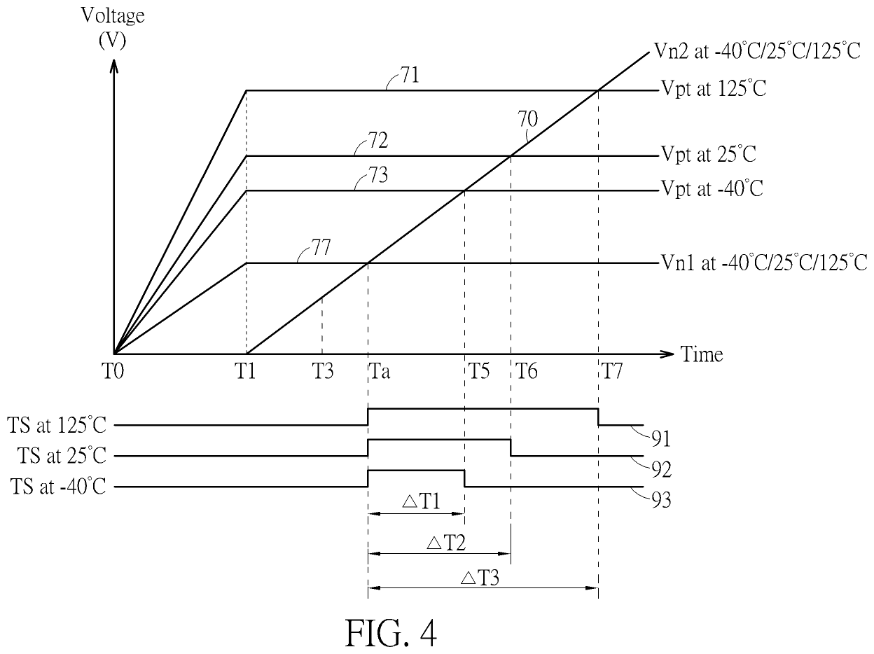

Please refer to FIG. 3 and FIG. 4. FIG. 4 is a timing diagram of related signals of the temperature sensing circuit 200 shown in FIG. 3. Before time T0, the microcontroller 60 resets the voltage difference across each of the capacitors Cn1, Cpt, and Cn2 to zero using the switches SW1, SW2 and SW3. In other words, the switches SW1, SW2 and SW3 are turned on to reset the voltage difference across each of the capacitors Cn1, Cpt, and Cn2 before time TO. In an embodiment of the present invention, the reference voltage Vss is a ground voltage, and the voltage differences across the capacitors Cn1, Cpt, and Cn2 are equal to Vn1, Vpt, and Vn2 respectively. Additionally, before time T0, the microcontroller 60 turns off the current sources 11 to 13, the sinking current sources 21 to 23, and the sensing amplifiers 31 and 32, and resets the count Ct of the counter 50 to 0. At time T0, the microcontroller 60 simultaneously turns off the switches SW1 and SW2, turns on the current sources 11 and 12, and turns on the sinking current sources 21 and 22, while keeping the switch SW3 turned on, the current source 13 turned off, and the sinking current source 23 turned off. Accordingly, the capacitors Cn1 and Cpt are charged by the currents ΔIn1 and Alpt respectively after time TO. At time T1, the microcontroller 60 simultaneously turns off the switches SW1, SW2, and SW3, the current sources 11 and 12 and the sinking current sources 21 and 22, and turns on the current source 13 and the sinking source 23. Therefore, after time T1, the voltages Vn1 and Vpt are held constant, and the voltage Vn2 is raised from zero. The curve 70 also represents the relationship between the voltage Vn2 and time at different temperatures: −40° C., 25° C., and 125° C. The curve 77 represents the relationship between the voltage Vn1 and time at different temperatures: −40° C., 25° C., and 125° C.

The sensing amplifier 31 compares the voltage Vpt with the voltage Vn2 to output the comparison result C1, the sensing amplifier 32 compares the voltage Vn1 with the voltage Vn2 to output the comparison result C2. The curves 91, 92, and 93 respectively represent the waveforms of the output signal TS at different temperatures: 125° C., 25° C., and −40° C. When the voltage Vn2 exceeds the voltage Vn1, the output signal TS is pulled up from low to high. When the voltage Vn2 exceeds the voltage Vpt, the output signal TS is pulled down from high to low. As shown in FIG. 4, when the temperature is −40° C., 25° C. or 125° C., the output signal TS is pulled up from low to high at time Ta, which is behind time T3. When the temperature is 125° C., the output signal TS is pulled down from high to low at time T7 (see the curve 91). When the temperature is 25° C., the output signal TS is pulled down from high to low at time T6 (see the curve 92). When the temperature is −40° C., the output signal TS is pulled down from high to low at time T5 (see the curve 93). The time duration between time T7 and Ta is equal to ΔT3, the time duration between time T6 and Ta is equal to ΔT2, and the time duration between time T5 and Ta is equal to ΔT1. The microcontroller 60 determines that the temperature is −40° C. according to the time duration ΔT1, determines that the temperature is 25° C. according to the time duration ΔT2, and determines that the temperature is 125° C. according to the time duration ΔT3.

In one embodiment, the microcontroller 60 activates the counter 50 at time T1. In a different embodiment, the microcontroller 60 activates the counter 50 at time T3 or at any time between T1 and Ta, in order to minimize the power consumption of the counter 50.

The microcontroller 60 may determine the temperature according to the count Ct of samples of the output signal TS sampled by the counter 50 during the time duration between a time when the voltage Vn2 exceeds the voltage Vn1 and a time when the voltage Vn2 exceeds the voltage Vpt. In detail, the microcontroller 60 determines that the temperature is −40° C. according to the count Ct of samples of the output signal TS sampled by the counter 50 during the time Ta and time T5, determines that the temperature is 25° C. according to the count Ct of samples of the output signal TS sampled by the counter 50 during the time Ta and time T6, and determines that the temperature is 125° C. according to the count Ct of samples of the output signal TS sampled by the counter 50 during the time Ta and time T7.

In an embodiment of the present invention, the microcontroller 60 may adjust the slope of the curve 70 to alter the time durations ΔT1, ΔT2, and ΔT3 by modulating the current ΔIn2. When the microcontroller 60 increases the current ΔIn2, the capacitor Cn2 charges more quickly, causing the voltage Vn2 to rise faster and the slope of the curve 70 to steepen. As a result, the time durations ΔT1, ΔT2, and ΔT3 shorten. Conversely, when the microcontroller 60 decreases the current ΔIn2, the capacitor Cn2 charges more slowly, causing the voltage Vn2 to rise more slowly and the slope of the curve 70 to flatten. Consequently, the time durations ΔT1, ΔT2, and ΔT3 lengthen. The microcontroller 60 can adjust the current ΔIn2 by modulating the current Ipt and/or the sinking current Isub. As the time durations ΔT1, ΔT2, and/or ΔT3 lengthen, the count Ct of samples of the output signal TS sampled by the counter 50 increases, enhancing the accuracy of the detected temperature T outputted by the microcontroller 60.

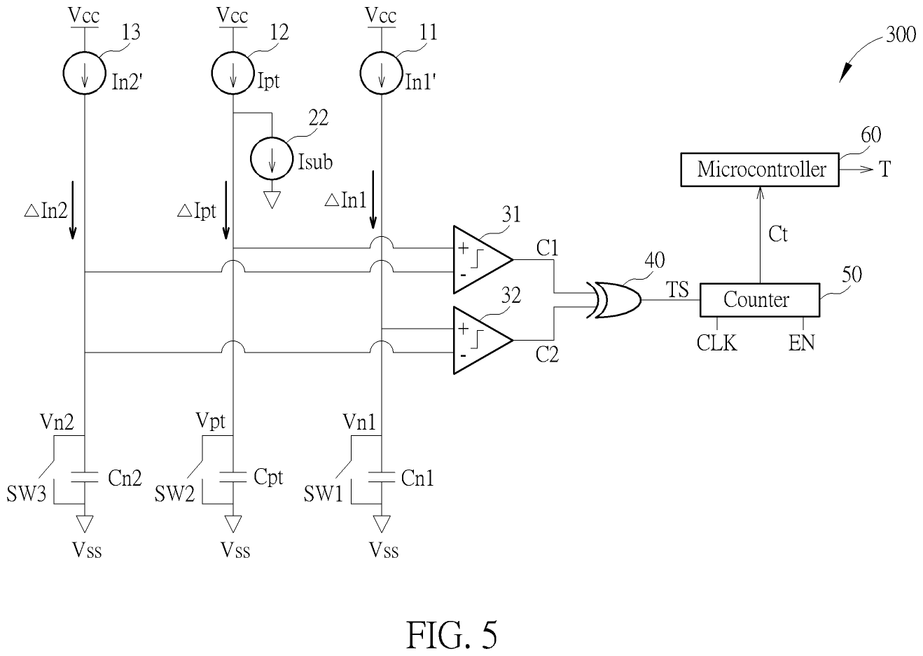

Please refer to FIG. 5. FIG. 5 is a schematic diagram of a temperature sensing circuit 300 according to another embodiment of the present invention. The temperature sensing circuit 300 is a differential sensing temperature sensor and comprises the three current sources 11, 12, and 13, the sinking current source 22, the three capacitors Cn1, Cpt, and Cn2, the three switches SW1, SW2, and SW3, the two sensing amplifiers 31 and 32, the XOR gate 40, the counter 50, and the microcontroller 60. In the embodiment, the current source 11 is configured to provide a current In1′, which is equal to the foresaid current ΔIn1. The current source 13 is configured to provide a current In2′, which is equal to the foresaid current ΔIn2. Therefore, the currents In1′, In2′, ΔIn1 and ΔIn2 remain constant within the temperature range to be detected by the temperature sensing circuit 300. Accordingly, the operations of the capacitors Cn1, Cpt, and Cn2, the three switches SW1, SW2, and SW3, the two sensing amplifiers 31 and 32, the XOR gate 40, the counter 50, and the microcontroller 60 of the temperature sensing circuit 300 in FIG. 5 are the same as the operations of the capacitors Cn1, Cpt, and Cn2, the three switches SW1, SW2, and SW3, the two sensing amplifiers 31 and 32, the XOR gate 40, the counter 50, and the microcontroller 60 of the temperature sensing circuit 200 in FIG. 3.

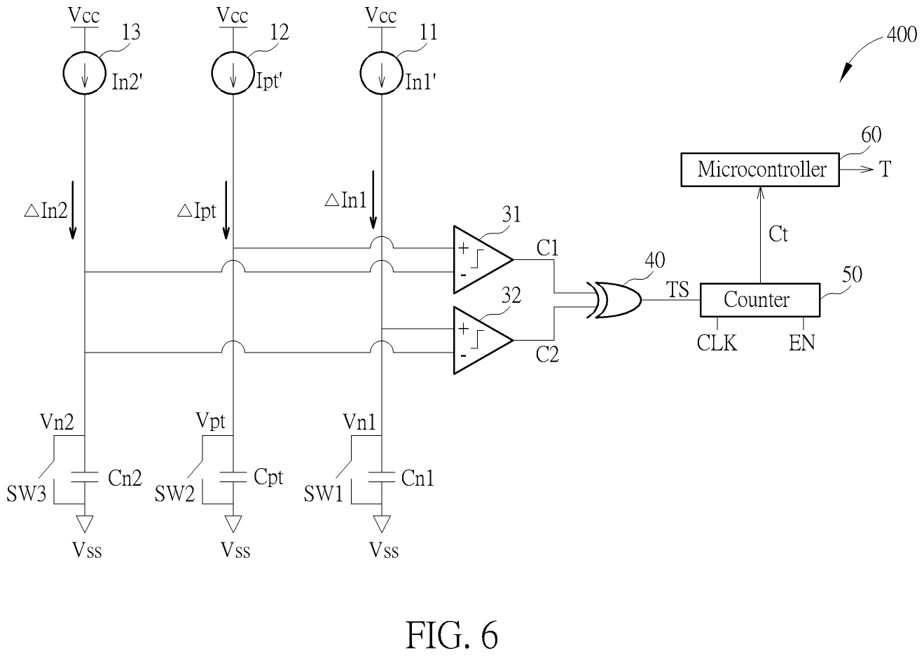

Please refer to FIG. 6. FIG. 6 is a schematic diagram of a temperature sensing circuit 400 according to another embodiment of the present invention. The temperature sensing circuit 400 is a differential sensing temperature sensor and comprises the three current sources 11, 12, and 13, the three capacitors Cn1, Cpt, and Cn2, the three switches SW1, SW2, and SW3, the two sensing amplifiers 31 and 32, the XOR gate 40, the counter 50, and the microcontroller 60. In the embodiment, the current source 11 is configured to provide a current In1′, which is equal to the foresaid current ΔIn1. The current source 12 is configured to provide a current Ipt′, which is equal to the foresaid current ΔIpt. The current source 13 is configured to provide a current In2′, which is equal to the foresaid current ΔIn2. Therefore, the currents In1′, In2′, ΔIn1, and ΔIn2 remain constant within the temperature range to be detected by the temperature sensing circuit 400. Accordingly, the operations of the capacitors Cn1, Cpt, and Cn2, the three switches SW1, SW2, and SW3, the two sensing amplifiers 31 and 32, the XOR gate 40, the counter 50, and the microcontroller 60 of the temperature sensing circuit 400 in FIG. 6 are the same as the operations of the capacitors Cn1, Cpt, and Cn2, the three switches SW1, SW2, and SW3, the two sensing amplifiers 31 and 32, the XOR gate 40, the counter 50, and the microcontroller 60 of the temperature sensing circuit 200 in FIG. 3.

An embodiment of the present invention provides a temperature sensing circuit employs a combination of current sources, capacitors, switches, two sensing amplifiers, an XOR gate, and a counter to accurately measure temperature within a specific range. The temperature sensing circuit uses three current sources, each with distinct characteristics, along with three capacitors for voltage storage. Switches are employed to reset voltage levels at the input ends of the two sensing amplifiers before the two sensing amplifiers compare the voltage levels to determine two time durations. An XOR gate processes the outputs from the two sensing amplifiers, and a counter utilizes a clock signal to sample the output from the XOR gate based on the two time durations, so as to provide a digital representation of the temperature.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A temperature sensing circuit, comprising:
a first current source configured to provide a first current, the first current being constant within a temperature range to be detected by the temperature sensing circuit;
a second current source configured to provide a second current, the second current being proportional to an absolute temperature within the temperature range;
a third current source configured to provide a third current, the third current being constant within the temperature range;
a first capacitor coupled to the first current source and a reference voltage;
a second capacitor coupled to the second current source and the reference voltage;
a third capacitor coupled to the third current source and the reference voltage;
a first switch coupled in parallel with the first capacitor;
a second switch coupled in parallel with the second capacitor;
a third switch coupled in parallel with the third capacitor;
a first sensing amplifier having a first input coupled to the second current source and the second capacitor, and a second input coupled to the third current source and the third capacitor;
a second sensing amplifier having a first input coupled to the first current source and the first capacitor, and a second input coupled to the third current source and the third capacitor;
an XOR gate having a first input coupled to an output of the first sensing amplifier, and a second input coupled to an output of the second sensing amplifier; and
a counter configured to sample an output signal outputted from the XOR gate according to a clock signal.

2. The temperature sensing circuit of claim 1, wherein the first capacitor is charged within a first time duration to provide a first voltage at one end of the first capacitor at an end of the first time duration;
wherein the second capacitor is charged within the first time duration to provide a second voltage at one end of the second capacitor at the end of the first time duration; and
wherein the third capacitor is charged within a second time duration after the first time duration to pull up a third voltage at one end of the third capacitor.

3. The temperature sensing circuit of claim 2, further comprising a microcontroller configured to determine a temperature according to a count of samples of the output signal sampled by the counter during a time duration between a time when the third voltage exceeds the first voltage and a time when the third voltage exceeds the second voltage.

4. The temperature sensing circuit of claim 1, further comprising:
a first sinking current source coupled to the first current source, and configured to drain a first sinking current from the first current source so as to provide a first charge current to the first capacitor, wherein the first sinking current and the first charge current are less than the first current;
a second sinking current source coupled to the second current source, and configured to drain a second sinking current from the second current source so as to provide a second charge current to the second capacitor, wherein the second sinking current and the second charge current are less than the second current; and
a third sinking current source coupled to the third current source, and configured to drain a third sinking current from the third current source so as to provide a third charge current to the third capacitor, wherein the third sinking current and the third charge current are less than the third current.

5. The temperature sensing circuit of claim 4, wherein the first charge current charges the first capacitor within a first time duration to provide a first voltage at one end of the first capacitor at an end of the first time duration;
wherein the second charge current charges the second capacitor within the first time duration to provide a second voltage at one end of the second capacitor at the end of the first time duration; and
wherein the third charge current charges the third capacitor within a second time duration to pull up a third voltage at one end of the third capacitor.

6. The temperature sensing circuit of claim 5, further comprising a microcontroller configured to determine a temperature according to a count of samples of the output signal sampled by the counter during a time duration between a time when the third voltage exceeds the first voltage and a time when the third voltage exceeds the second voltage.

7. The temperature sensing circuit of claim 5, wherein the first current source, the second current source, the first sinking current source, and the second sinking current source are turned on and the third current source and the third sinking current source are turned off within the first time duration; and
wherein the first current source, the second current source, the first sinking current source, and the second sinking current source are turned off and the third current source and the third sinking current source are turned on within the second time duration.

8. The temperature sensing circuit of claim 4, wherein the first sinking current, the second sinking current, and the third sinking current are equal.

9. The temperature sensing circuit of claim 4, wherein first sinking current source, the second sinking current source, and the third sinking current source form a current mirror.

10. The temperature sensing circuit of claim 1, further comprising a sinking current source coupled to the second current source, and configured to drain a sinking current from the second current source so as to provide a charge current to the second capacitor, wherein the sinking current and the charge current are less than the second current.

11. The temperature sensing circuit of claim 10, wherein the first current charges the first capacitor within a first time duration to provide a first voltage at one end of the first capacitor at an end of the first time duration;
wherein the charge current charges the second capacitor within the first time duration to provide a second voltage at one end of the second capacitor at the end of the first time duration; and
wherein the third current charges the third capacitor within a second time duration to pull up a third voltage at one end of the third capacitor.

12. The temperature sensing circuit of claim 11, further comprising a microcontroller configured to determine a temperature according to a count of samples of the output signal sampled by the counter during a time duration between a time when the third voltage exceeds the first voltage and a time when the third voltage exceeds the second voltage.

13. The temperature sensing circuit of claim 11, wherein the first current source, the second current source, and the sinking current source are turned on and the third current source is turned off within the first time duration; and
wherein the first current source, the second current source, and the sinking current source are turned off and the third current source is turned on within the second time duration.

14. The temperature sensing circuit of claim 1, wherein the first current charges the first capacitor within a first time duration to provide a first voltage at one end of the first capacitor at an end of the first time duration;
wherein the second current charges the second capacitor within the first time duration to provide a second voltage at one end of the second capacitor at the end of the first time duration; and
wherein the third current charges the third capacitor within a second time duration after the first time duration to pull up a third voltage at one end of the third capacitor.

15. The temperature sensing circuit of claim 14, further comprising a microcontroller configured to determine a temperature according to a count of samples of the output signal sampled by the counter during a time duration between a time when the third voltage exceeds the first voltage and a time when the third voltage exceeds the second voltage.

16. The temperature sensing circuit of claim 1, further comprising a microcontroller configured to determine a temperature according to a count of samples of the output signal sampled by the counter.

17. The temperature sensing circuit of claim 1, wherein the first current and the third current are equal.

18. The temperature sensing circuit of claim 1, wherein the first capacitor, the second capacitor and the third capacitor have equal capacitance.

19. A method of detecting a temperature, comprising:
charging a first capacitor using a first charge current within a first time duration to provide a first voltage at one end of the first capacitor at an end of the first time duration, wherein the first charge current is constant within a temperature range;
charging a second capacitor using a second charge current within the first time duration to provide a second voltage at one end of the second capacitor at the end of the first time duration, wherein the second charge current is proportional to an absolute temperature within the temperature range;
charging a third capacitor using a third charge current within a second time duration after the first time duration to pull up a third voltage at one end of the third capacitor, wherein the third charge current is constant within the temperature range;
measuring a time duration between a time when the third voltage exceeds the first voltage and a time when the third voltage exceeds the second voltage; and
outputting a detected temperature according to the time duration.

20. The method of claim 19, wherein the first charge current and the third charge current are equal.
